(19) United States
(12) Patent Application Publication
(10) Pub. No.: US 2005/0122659 A1
(43) Pub. Date: Jun. 9, 2005

(54) Space charge dissipation type air terminal

(76) Inventor: Young-Ki Chung, Seoul (KR)

Correspondence Address: DR. MARK FRIEDMAN LTD.;C/o Bill Polkinghom, Discovery Dispatch, 9003 Florin Way, Upper Marlboro, MD, 20772, US

(21) Appl. No.: 10/762,379

(22) Filed: Jan. 23, 2004

(30) Foreign Application Priority Data
Dec. 9, 2003 (KR) 2003/88842

(51) Int. Cl. H02B 1/00

(52) U.S. Cl. 361/220

(57) ABSTRACT

A space charge dissipation type air terminal including a base fixed to a floor, a fixing rod installed on the base and a fixing means for fixing the preliminary discharge member to the base or to the fixing rod. The fixing rod includes a preliminary discharge member, an auxiliary discharge member, an isolation member and a coupling member, sequentially coupled to the fixing rod, the isolation member is disposed between the fixing rod and he auxiliary discharge member. The fixing means includes a preliminary discharge member with a discharge fin assembly logitudinally coupled to a coupling ring and including a number of discharge fins, and a discharge panel for supporting the discharge fin assembly. The discharge fin assembly is aligned around a ring member, forming a gap between the discharge fin assembly and the auxiliary discharge member.

### BACKGROUND OF THE INVENTION

1. Field of the Invention

The present invention relates to a space charge dissipation type air terminal, and more particularly to a space charge dissipation type air terminal installed at a rooftop of a building so as to preliminarily dissipate an electric charge of an earth in a space as a thundercloud approaches the building, thereby protecting the building from electric shock when a thunderbolt falls.

2. Description of the Prior Art

In general, an air terminal is installed at an uppermost part of a building in order to safely induce impulse current of a thundercloud to the earth, thereby preventing the building, persons and animals from being damaged.

FIG. 1 shows a conventional air terminal.

As shown in FIG. 1, a conventional air terminal 10 includes a base 30 fixed to a building, a supporting section 16 coupled to the base 30, and a suction ball 12 coupled to the supporting section 16.

The base 30 is provided with a grounding member 34, to which an air terminal line connected to a ground electrode (not shown) is coupled.

The suction ball 12 has a coupling hole 12a, into which an end portion of the supporting section 16 is inserted.

The supporting section 16 includes a suction part 16c consisting of a supporting rod 16a and suction fins 16b provided around the supporting rod 16a The suction part 16c may easily absorb impulse current when thunderbolt falls into a side of the supporting section 16. In detail, the suction part 16c is fabricated by twisting a plurality of supporting rods 16a after installing the suction fins 16 having a predetermined length lengthwise the supporting rods 16a.

The conventional air terminal 10 having the above structure absorbs impulse current through the suction ball 12 and the suction fins 16b so as to induce the impulse current into the earth through the air terminal line connected to the grounding member 34 provided at an upper surface of the base 30.

However, since a great amount of impulse current is generated when the thunderbolt falls, communication equipment, computers and electric appliances are broken or malfunctioned due to an inductive interference even if the conventional air terminal 10 safely guides impulsive current into the earth.

In order to solve the above problem, space charge dissipation type air terminals have been recently suggested. Such space charge dissipation type air terminals preliminarily dissipate an electric charge of an earth in a space as a thundercloud approaches the building such that voltage to ground is lowered, thereby protecting the building from electric shock when a thunderbolt falls.

Examples of such space charge dissipation type air terminals are shown in FIGS. 2 to 5.

FIG. 2 shows a structure of a space charge dissipation type air terminal 100 disclosed in Korean Utility Model Registration No. 305180.

As shown in FIG. 2, the space charge dissipation type air terminal 100 includes a base 110, a discharge member 120, an isolation member 150 and a discharge cap 160 coupled to the discharge member 120 by interposing the isolation member 150 therebetween. The isolation member 150 is made of an insulation material, such as plastic. The isolation member 150 is disposed between the discharge cap 160 and the discharge member 120, which are made from conductive materials. In addition, an upper cap is coupled to an upper portion of the space charge dissipation type air terminal 100.

When a thundercloud having a minus polarity approaches the space charge dissipation type air terminal 100, the base 110, the discharge member 120 and the upper cap 140 represent a plus polarity, and the discharge cap 160 represents a minus polarity. In addition, a great potential difference is created between the discharge member 120 and the discharge cap 160, so a corona discharge is created in atmosphere. Thus, voltage to ground is lowered so that electric shock caused by the thunderbolt is maximally reduced. In addition, due to an electric dipole phenomenon caused by static induction, the above components have the opposite polarities.

As shown in FIG. 2, the discharge member 120 is fabricated by twisting a plurality of supporting rods 126a after installing discharge fins 128a on the supporting rods 126a. Thus, the discharge fins 128a are aligned in a spiral pattern. The discharge fins 128a facilitate the preliminary discharge.

When the supporting rods 126a are coupled to the upper cap 140 and a coupling protrusion 112, additional components, such as a connecting member 124 and a fixing member 122, are required.

FIG. 3 shows a structure of a space charge dissipation type air terminal disclosed in Korean Utility Model Registration No. 305185.

The space charge dissipation type air terminal shown in FIG. 3 is similar to the space charge dissipation type air terminal shown in FIG. 2, except that a plurality of discharge members 134 including discharge fins 134a and supporting rods 125 are radially arranged.

FIG. 4 shows a structure of a space charge dissipation type air terminal disclosed in Korean Utility Model Registration No. 305193.

A structure and an operation principle of the space charge dissipation type air terminal shown in FIG. 4 is similar to those of the space charge dissipation type air terminals shown in FIG. 2 and FIG. 3, except for an alignment of supporting members 104 and a discharge member 120.

FIG. 5 shows a structure of a space charge dissipation type air terminal disclosed in Korean Patent No. 2003-0026913.

As shown in FIG. 5, a protecting member 66 and an auxiliary discharge member 65, which are made from conductive materials, are aligned between an isolation member 62 and a discharge cap 67. In addition, a distance compensation member 70 is installed between a discharge member 40 and a potential attenuation device 60. Therefore, when the thundercloud approaches the space charge dissipation type air terminal, a corona discharge is generated between the discharge cap 67 having a minus polarity and the distance compensation member 70 having a plus polarity. The remaining parts of the space charge dissipation type air terminal shown in FIG. 5 are identical to corresponding parts of space charge dissipation type air terminal shown in FIG. 2. In order to facilitate the preliminary discharge, support rods 45 and discharge fins 43 are installed below the distance compensation member 43.

However, such conventional space charge dissipation type air terminals have a disadvantage that a process for manufacturing the discharge member is very complicated. That is, since the discharge member is fabricated by twisting a plurality of rods after inserting a plurality of discharge fins having a predetermined length into the rods in such a manner that the discharge fins are aligned in a spiral pattern, a process for supporting the rods, a process for inserting the discharge fins into the rods and a process for twisting the rods are necessarily required.

In addition, the twisted support rod may be coupled to the potential attenuation device or the distance compensation member by using a fixing member and a connection member, so the number of parts and process steps are increased.

### SUMMARY OF THE INVENTION

Therefore, the present invention has been made in view of the above-mentioned problems, and it is an object of the present invention to provide a space charge dissipation type air terminal having a simple structure and a superior preliminary discharge performance with simplifying a fabricating process thereof.

In order to accomplish the above object, the present invention provides a space charge dissipation type air terminal comprising: a base fixed to a floor;
a fixing rod installed on the base, in which a preliminary discharge member, an auxiliary discharge member, an isolation member, and a coupling member are sequentially coupled to the fixing rod and the isolation member is disposed between the fixing rod and the auxiliary discharge member; and a fixing means for fixing the preliminary discharge member to the base or to the fixing rod, wherein the preliminary discharge member includes a discharge fin assembly longitudinally coupled to a coupling ring and having a plurality of discharge fins, and a discharge panel for supporting the discharge fin assembly, the discharge fin assembly is aligned around a ring member, and a gap is formed between the discharge fin assembly and the auxiliary discharge member.

According to an exemplary embodiment of the present invention, at least two sets of discharge assemblies are longitudinally aligned along the fixing rod, wherein each of the discharge assemblies includes the isolation member, the auxiliary discharge member, the ring member and the discharge fin assembly.

An interval member having a ring shape is interposed between the discharge assemblies.

The coupling member includes a cap member or a nut.

The isolation member includes a hollow pipe section, which extends downwards and through which the fixing rod extends.

The ring member and the auxiliary discharge member are sequentially aligned around the hollow pipe section from a lower portion of the hollow pipe section.

An extension member, through which the fixing rod extends, is integrally formed with a lower surface of the discharge panel and a fixing screw section is installed at a side of the extension member.

A supporting pipe, through which the fixing rod extends, is aligned between the preliminary discharge member and the base.

### BRIEF DESCRIPTION OF THE DRAWINGS

The foregoing and other objects, features and advantages of the present invention will become more apparent from the following detailed description in conjunction with the accompanying drawings in which:

FIG. 1 is a perspective view of a conventional air terminal;

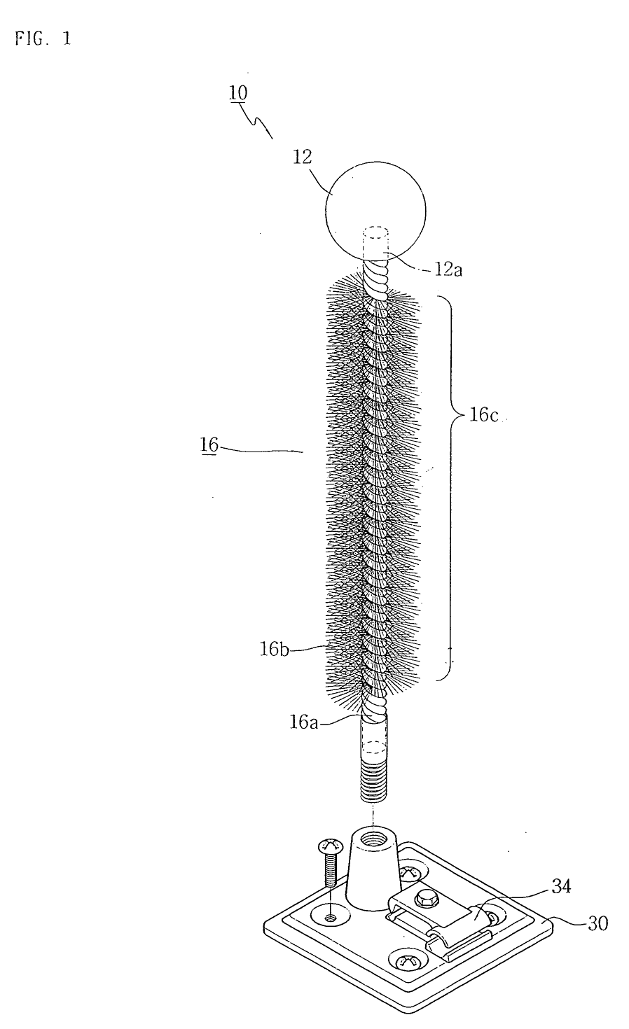

FIG. 2 is a perspective view of a conventional space charge dissipation type air terminal;

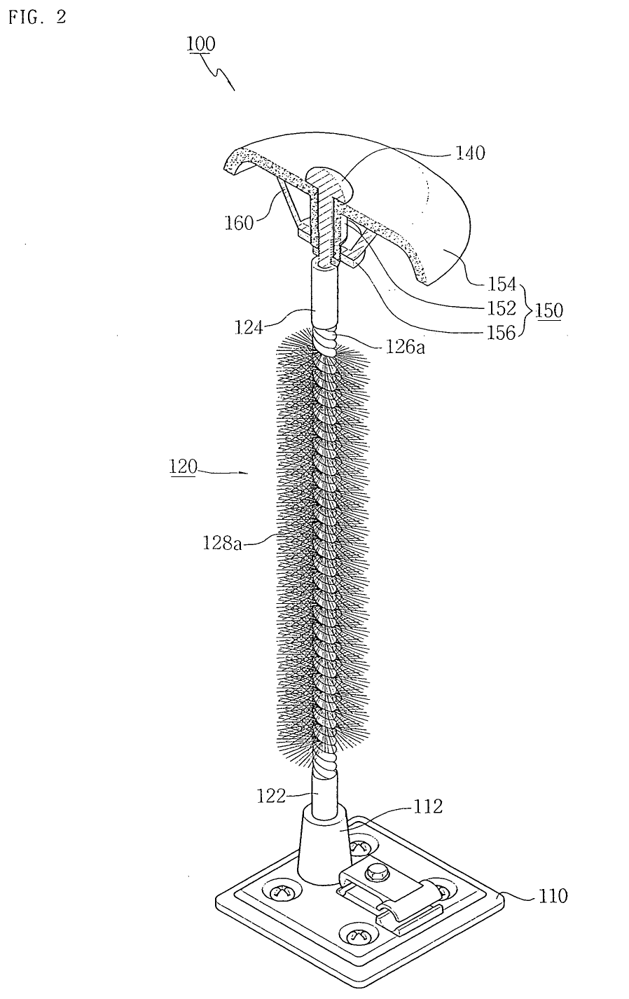

FIG. 3 is a perspective view showing another conventional space charge dissipation type air terminal;

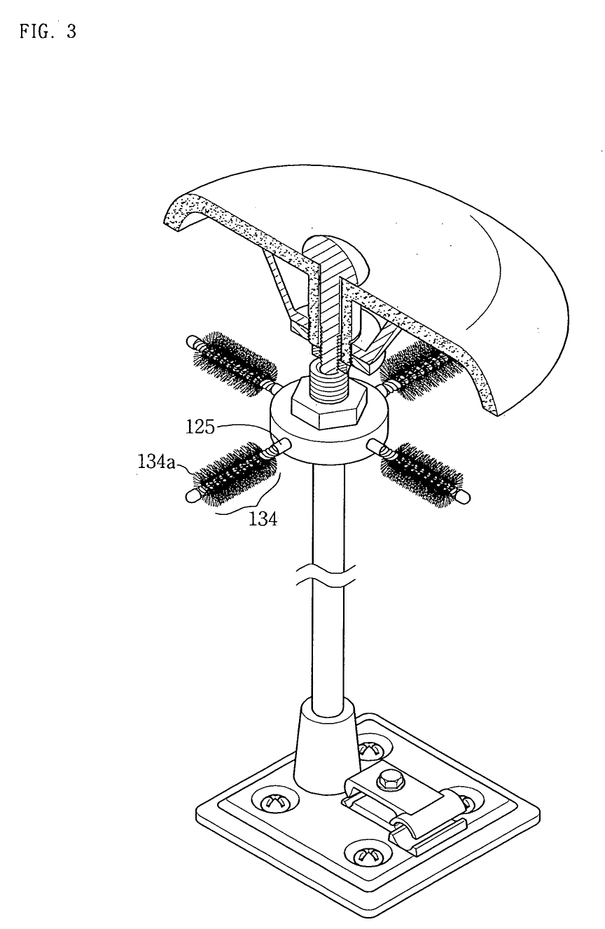

FIG. 4 is a perspective view showing another conventional space charge dissipation type air terminal;

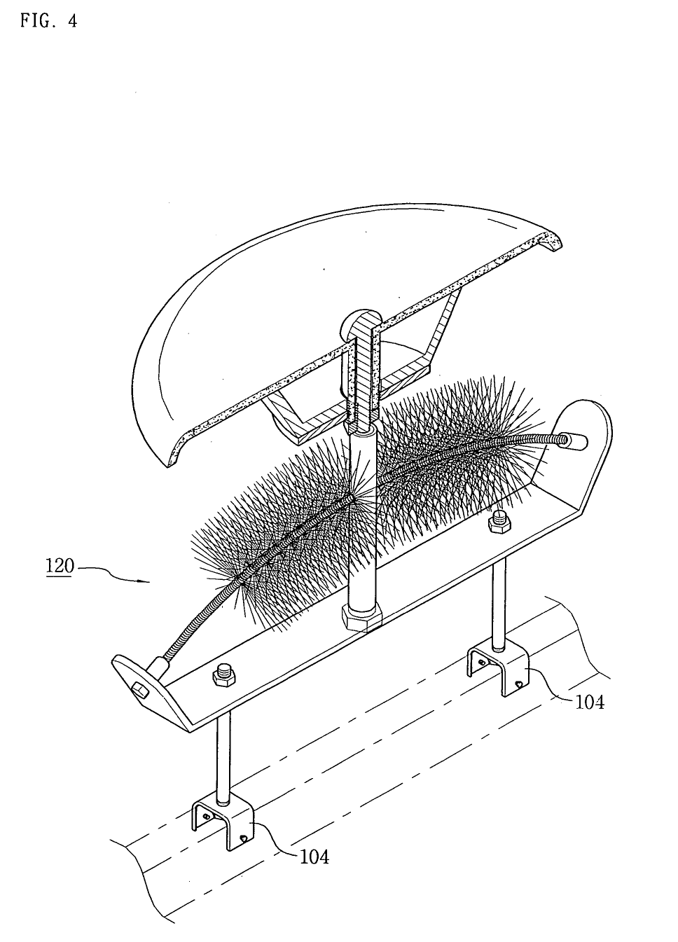

FIG. 5 is a perspective view showing another conventional space charge dissipation type air terminal;

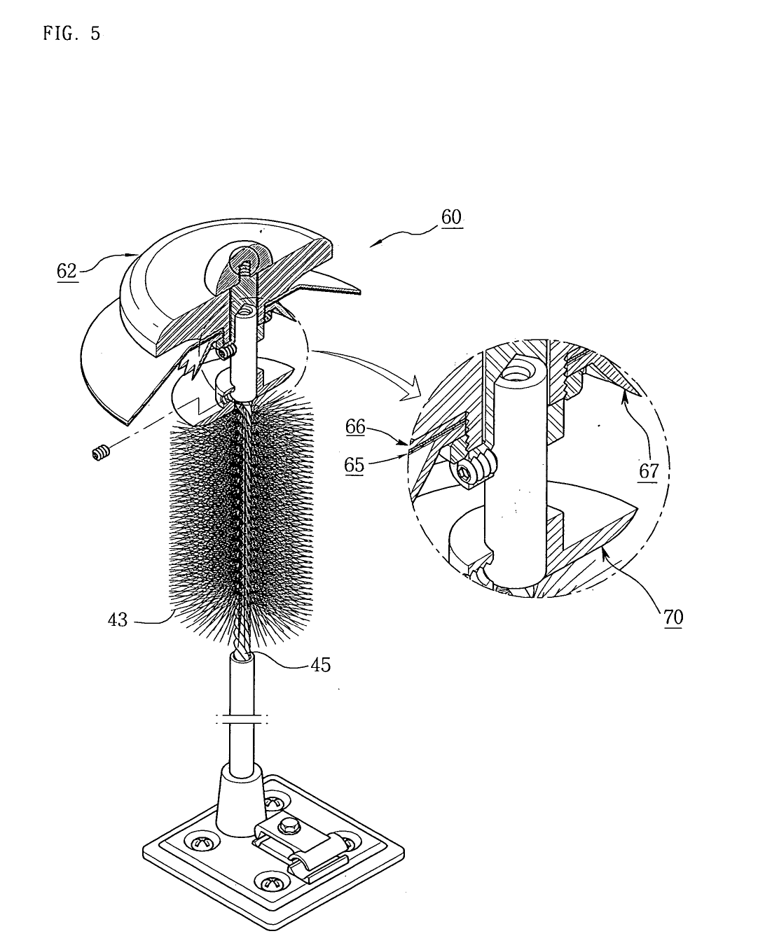

FIG. 6 is a perspective view showing a space charge dissipation type air terminal according to a first embodiment of the present invention;

FIG. 7 is an exploded perspective view of a space charge dissipation type air terminal shown in FIG. 6;

FIG. 8 is a perspective view showing a space charge dissipation type air terminal according to a second embodiment of the present invention; and

FIG. 9 is a perspective view showing a space charge dissipation type air terminal according to a third embodiment of the present invention.

### DETAILED DESCRIPTION OF THE PREFERRED EMBODIMENTS

Reference will now be made in detail to the preferred embodiments of the present invention.

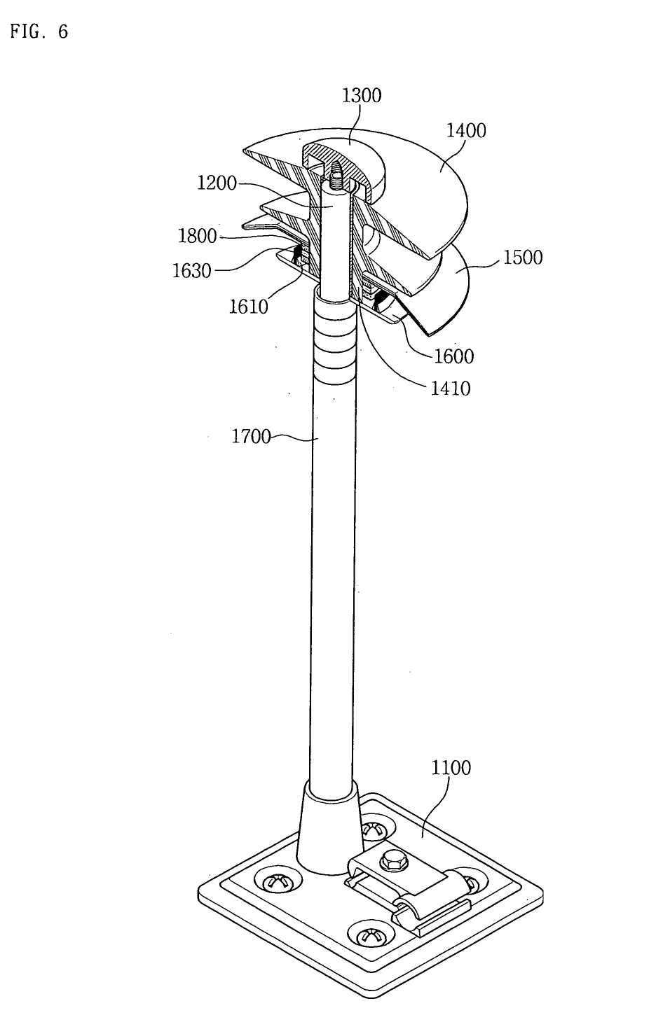

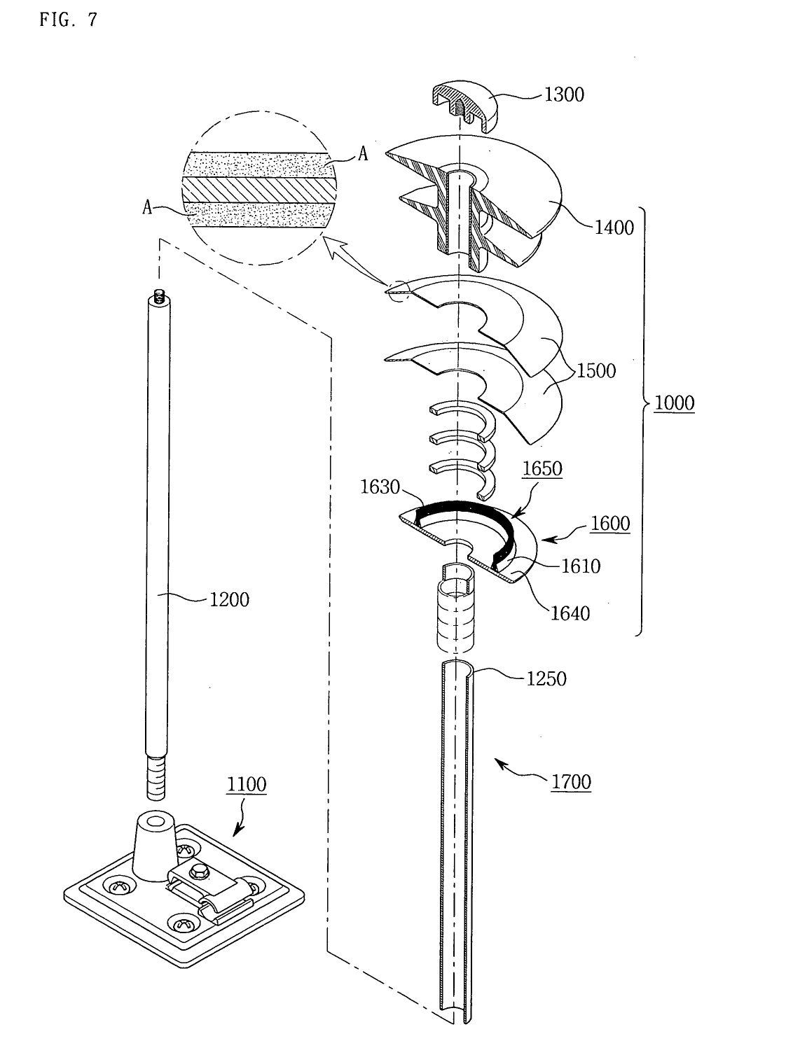

FIGS. 6 and 7 show a space charge dissipation type air terminal according to a first embodiment of the present invention.

As shown in FIGS. 6 and 7, the space charge dissipation type air terminal according to the first embodiment of the present invention includes a base 1100 fixed to a floor and a fixing rod 1200 installed on the base 1100. A preliminary discharge member 1600, an auxiliary discharge member 1500, an isolation member 1400, and a coupling member 1300 are sequentially coupled to the fixing rod 1200. In addition, a fixing member 1700 is provided to fix the preliminary discharge member 1600 to the base 1100.

The coupling member 1300 is a part coupled to an uppermost portion of the fixing rod 1200 so as to prevent components coupled to the fixing rod 1200 from being separated from the fixing rod 1200. The coupling member 1300 can be fabricated in the form of a cap or a nut.

The isolation member 1400 includes two disc-shaped insulators. A hollow pipe section 1410 is formed at a center of the isolation member 1400. The fixing rod 1200 is accommodated in the hollow pipe section 1410.

In addition a ring member 1800 and the auxiliary discharge member 1500 are sequentially aligned around the hollow pipe section 1410 from a lower portion of the hollow pipe section 1410. At this time, the ring member 1800 is closely coupled to the hollow pipe section 1410 so that the auxiliary discharge member 1500 is prevented from being separated from the hollow pipe section 1410 due to a tare thereof. The ring member 1800 is made from an insulation material, such as plastic.

Two auxiliary discharge members 1500 are provided so as to create a dual layer effect. Thus, a discharge action is rapidly carried out. The discharge is more rapidly carried out if an insulation material layer A, such as epoxy rein, is coated on a surface of an upper auxiliary discharge member. In addition, each of the auxiliary discharge members 1500 is slightly inclined from a center thereof towards an outer peripheral portion thereof.

The preliminary discharge member 1600 includes a discharge fin assembly 1650 and a discharge panel 1640 for supporting the discharge fin assembly 1650.

The discharge fin assembly 1650 includes a strip member provided with a plurality of discharge fins 1630 and longitudinally coupled to a coupling ring 1610. In detail, the discharge fin assembly 1650 can be simply fabricated by pressing two thin strips with each other after inserting a plurality of discharge fins 1630 into two thin strips. The discharge fin assembly 1650 is preferably fixed to the discharge panel 1640 by welding a predetermined part thereof, which is opposite to a part having the discharge fins 1630, to the discharge panel 1640. However, it is also possible to align the discharge fin assembly 1650 to make contact with the discharge panel 1640. In this case, there is necessary to prevent the discharge fin assembly 1650 and the discharge panel 1640 from moving with respect to each other.

The discharge fin assembly 1650 has a circular shape and is aligned around the ring member 1800. It is preferred to closely align the discharge fin assembly 1650 around the ring member 1800. The discharge panel 1640 is formed with a hole for allowing the discharge panel to be coupled with the fixing rod 1200.

At this time, a longitudinal length of the discharge fins 1630 must be properly predetermined in such a manner that a gap is formed between the discharge fin assembly 1650 and the auxiliary discharge member 1500.

A supporting pipe 1250, through which the fixing rod 1200 extends, is disposed between the preliminary discharge member 1600 and a base 1100. Thus, an additional part for fixing the preliminary discharge member 1600 to the fixing rod 1200 is not required.

In addition, although the isolation member 1400, the auxiliary discharge member 1500, the discharge fin assembly 1650, and the discharge panel 1640 are illustrated as circular shapes when viewed in a plan view, it is also possible to modify the shapes of the above components. That is, peripheral portions of the above components can be formed as angular shapes.

The space charge dissipation type air terminal having the above structure can be fabricated in a simple manner, so an assembling process thereof can be simplified and productivity thereof can be improved.

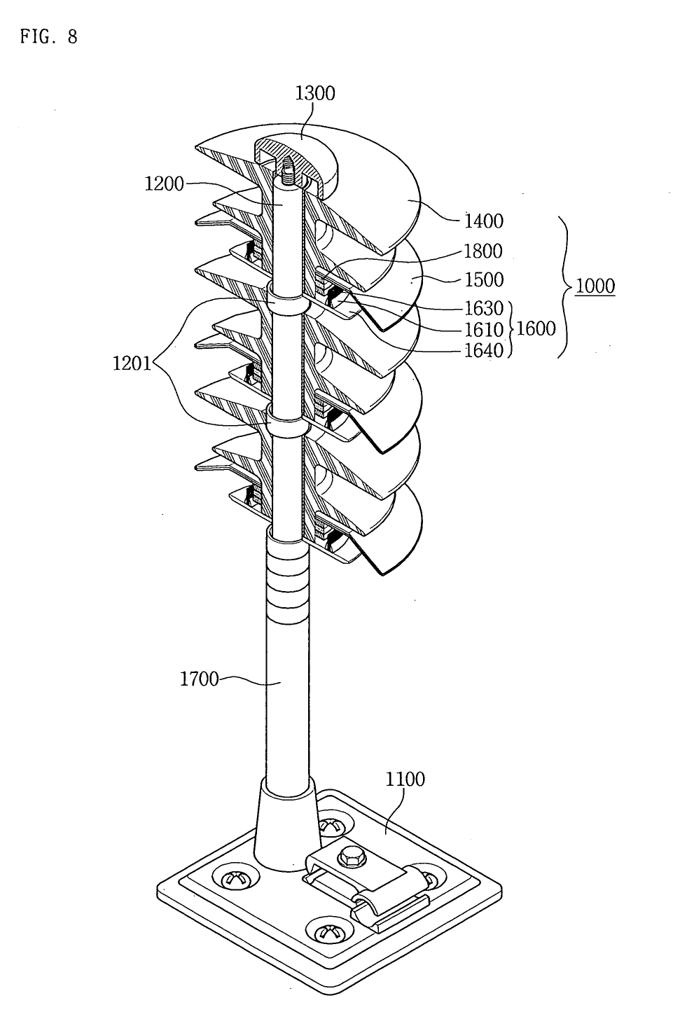

FIG. 8 shows a space charge dissipation type air terminal according to a second embodiment of the present invention, in which at least two sets of discharge assemblies 1000 including an isolation member, an auxiliary discharge member 1500, a ring member 1800 and a discharge fin assembly 1650 are longitudinally installed along a fixing rod 1200.

In this case, an interval member 1201 made from a conductive material is installed between discharge assemblies 1000.

In addition, a supporting pipe 1250, through which the fixing rod 1200 extends, is positioned between a lowest discharge assembly 1000 and a base 1100.

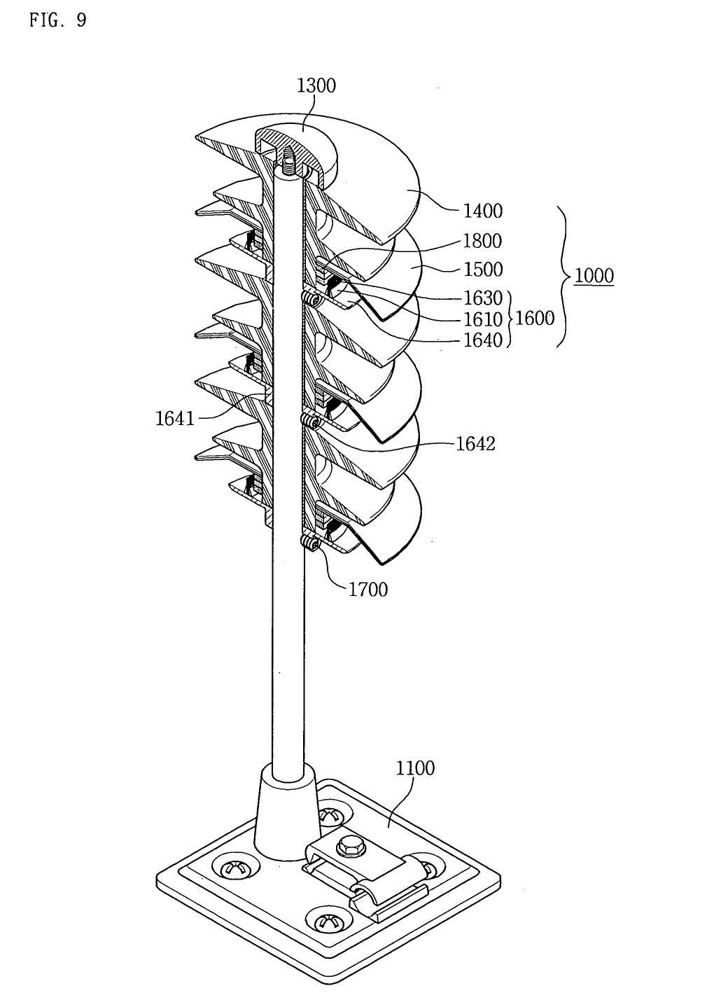

In addition, FIG. 9 shows a space charge dissipation type air terminal according to a third embodiment of the present invention having a fixing member 1700 different from fixing members described in first and second embodiments of the present invention.

As shown in FIG. 9, an extension member 1641, through which the fixing rod 1200 passes, is integrally formed with a lower surface of a discharge panel 1640. In addition, a fixing screw section 1642 is installed at a side of the extension member 1641.

When a thundercloud having a minus polarity approaches a building equipped with the space charge dissipation type air terminal of the present invention, a plus charge is concentrated on the coupling member 1300, the preliminary discharge member 1600, the discharge fin assembly 1650 and the discharge panel 1640, which are sequentially coupled with the fixing rod 1200, and the auxiliary discharge member 1500, which is insulated from the above components, is charged with a minus charge, so a preliminary discharge is generated in a space between the discharge fin assembly 1650 and the auxiliary discharge member 1500, thereby significantly decreasing a ground potential value.

As described above, the space charge dissipation type air terminal according to the present invention has a simple structure and can be fabricated through a simple manufacturing process as compared with conventional space charge dissipation type air terminals, so a manufacturing cost thereof can be reduced and productivity thereof can be improved.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A space charge dissipation type air terminal comprising:
a base fixed to a floor;
a fixing rod installed on the base, in which a preliminary discharge member, an auxiliary discharge member, an isolation member, and a coupling member are sequentially coupled to the fixing rod and the isloation member is disposed between the fixing rod and the auxiliary discharge member; and
a fixing means for fixing the preliminary discharge member to the base or to the fixing rod, wherein the preliminary discharge member includes a discharge fin assembly longitudinally coupled to a coulping ring and having a plurality of discharge fins, and a discharge panel for supporting the discharge fin assembly, the discharge fin assembly is aligned around a ring member, and a gap is formed between the discharge fin assembly and the auxiliary discharge member.

2. The space charge dissipation type air terminal as claimed in claim 1, further comprising at least two sets of discharge assemblies longitudinally aligned along the fixing rod, wherein each of the discharge assemblies includes the isolation member, the auxiliary discharge member, the ring member and the discharge fin assembly.

3. The space charge dissipation type air terminal as claimed in claim 2, wherein an interval member having a ring shape is interposed between the discharge assemblies.

4. The space charge dissipation type air terminal as claimed in claim 1 wherein the coupling member includes a cap member or a nut.

5. The space charge dissipation type air terminal as claimed in claim 2, wherein the coupling member includes a cap member or a nut.

6. The space charge dissipation type air terminal as claimed in claim 3, wherein the coupling member includes a cap member or a nut.

7. The space charge dissipation type air terminal as claimed in claim 1, wherein the isolation member includes a hollow pipe section, which extends downwards and through which the fixing rod extends.

8. The space charge dissipation type air terminal as claimed in claim 2, wherein the isolation member includes a hollow pipe section, which extends downwards and through which the fixing rod extends.

9. The space charge dissipation type air terminal as claimed in claim 3, wherein the isolation member includes a hollow pipe section, which extends downwards and through which the fixing rod extends.

10. The space charge dissipation type air terminal as claimed in claim 7 wherein the ring member and the auxiliary discharge member are sequentially aligned around the hollow pipe section from a lower portion of the hollow pipe section.

11. The space charge dissipation type air terminal as claimed in claim 8 wherein the ring member and the auxiliary discharge member are sequentially aligned around the hollow pipe section from a lower portion of the hollow pipe section.

12. The space charge dissipation type air terminal as claimed in claim 9 wherein the ring member and the auxiliary discharge member are sequentially aligned around the hollow pipe section from a lower portion of the hollow pipe section.

13. The space charge dissipation type air terminal as claimed in claim 1, wherein an extension member, through which the fixing rod extends, is integrally formed with a lower surface of the discharge panel and a fixing screw section is installed at a side of the extension member.

14. The space charge dissipation type air terminal as claimed in claim 2, wherein an extension member, through which the fixing rod extends, is integrally formed with a lower surface of the discharge panel and a fixing screw section is installed at a side of the extension member.

15. The space charge dissipation type air terminal as claimed in claim 3, wherein an extension member, through which the fixing rod extends, is integrally formed with a lower surface of the discharge panel and a fixing screw section is installed at a side of the extension member.

16. The space charge dissipation type air terminal as claimed in claim 1, wherein a supporting pipe, through which the fixing screw section is installed at a side of the extension member.

17. The space charge dissipation type air terminal as claimed in claim 2, wherein a supporting pipe, through which the fixing screw section is installed at a side of the extension member.

18. The space charge dissipation type air terminal as claimed in claim 3, wherein a supporting pipe, through which the fixing screw section is installed at a side of the extension member.
